(19) United States
(12) Patent Application Publication
(10) Pub. No.: US 2008/0108290 A1
(43) Pub. Date: May 8, 2008

(54) Fume hood

(76) Inventors: Warren L. Zeigler, AuGres, MI (US); Robert M. Berlin, Linwood, MI (US); David A. Sweitzer, Toledo, OR (US)

Correspondence Address: MCKELLAR IP LAW, PLLC, 784 SOUTH POSEYVILLE ROAD, MIDLAND, MI, 48640, US

(21) Appl. No.: 11/980,280

(22) Filed: Oct. 30, 2007

Related U.S. Application Data
(60) Provisional application No. 60/856,134, filed on Nov. 2, 2006.

(51) Int. Cl. B08B 15/02

(52) U.S. Cl. 454/56

(57) ABSTRACT

An improved fume hood that has an external sensor that automatically controls at least one lighting fixture located on or in the fume hood such that when a person is sensed in front of the fume hood, the light in the fume hood will automatically turn on. Once the technician is not sensed in front of the fume hood, the control module will delay and then turn the fume hood light off.

This application claims priority from U.S. Provisional Patent Application 60/856,134 filed Nov. 2, 2006.

### BACKGROUND OF THE INVENTION

This invention deals with an improved fume hood that has an external sensor that automatically controls at least one lighting fixture associated with the fume hood such that when a technician is sensed in front of the fume hood, the light will automatically turn on. Once the technician is not sensed in front of the fume hood, the control module will delay and then turn the fume hood light off and conserve energy.

Fume hoods have become very sophisticated over the last several years, going from manually operated sashes to automatically controlled; innovations in air volume control, further innovations with regard to manipulations of the entire fume hood with regard to each of the components interrelating to conserve air and to allow the user to have essentially a non-hands on use of the fume hood with the highest safety ever.

Such fume hoods can be found in U.S. Pat. No. 4,502,375, issued on Mar. 5, 1985 to Hignite, et al that deals with a fume hood sash operator system and a fume hood that contains such a system. The sash operator is constructed to operate with a belt drive and a clutch mechanism to that the sash member can be stopped, started, moved up or down to accommodate changes in the flow or air moving through the hood structure and to provide a safe, durable, energy-saving sash operating system.

Another system can be found in U.S. Pat. No. 4,774,878, that issued on Oct. 4, 1988 to Berlin, et al that deals with a sash operator that is constructed to operate from a pressure fluid cylinder so that the sash member can be stopped, started, moved up or down to accommodate changes in the flow of air moving through the hood structure and to provide a safe, durable, energy saving sash operating system.

In U.S. Pat. No. 5,759,096, that issued on Jun. 2, 1998, to Berlin, et al, there is disclosed, sash operators that are constructed to operate from a pressure fluid cylinder which has no outside operating parts with respect to the movement of the piston in the cylinder. The unique construction of the pressure fluid cylinder makes it very useful for fume hood construction because of the overall small dimensions of the pressure fluid cylinder and the ability to start the piston by overcoming the inertia of the piston using very low air or fluid pressures.

There is also disclosed a fume hood having a driven sash and a travel interference system for the sash that can be found in U.S. Pat. No. 6,024,638, that issued on Feb. 15, 2000. The addition of a travel interference system for the moveable sash to prevent accidents and the possible breakage of glassware and the like provides for a safer fume hood.

U.S. Patent publication US 2006/0079164 A1 published on Apr. 13, 2006 deals with a fume hood that has a pressure sensitive switch disposed on the bottom surface of the movable sash member that provides pressure on the pressure sensitive switch in excess of a threshold limit either by a user pressing against it or by the movable sash member encountering an object left within the access opening, thereby ceasing movement of the movable sash member. This publication also discloses the use of an operator sensor capable of varying the opening of the sash within the opening of the fume hood.

None of these references disclose or make obvious the invention claimed herein.

### THE INVENTION

Thus, the invention herein deals with an improved fume hood, the improvement comprising in combination a fume hood having a front fascia, a coverable opening, and a movable covering for the opening.

There is an active presence sensor mounted on the fume hood. In addition, there is a lighting control operator box associated with a timer that has adjustability ranging from seconds to hours.

An electrical cable, electrically connected to the active presence sensor is also connected to the lighting control operator box and the lighting control operator box has an electrical cable electrically connected to a fume hood lighting fixture.

A second embodiment is an improved fume hood, the improvement comprising in combination a fume hood having a front fascia, a coverable opening, and movable doors covering the opening as opposed to a moveable sash.

There is an active presence sensor mounted on the fume hood, and a lighting control operator box that may house a timer, wherein the timer has adjustability ranging from seconds to hours.

There is an electrical cable, electrically connected to the active presence sensor and to the lighting control operator box and the lighting control operator box has an electrical cable electrically connected to a fume hood lighting fixture.

A further embodiment is a fume hood as set forth just Supra, in which there is, in addition, an automatic sash positioning system to control the positioning of the sash in the opening.

Yet another embodiment of this invention is an improved fume hood as set forth just Supra, which is a fume hood having a variable air volume.

Still further, there is contemplated within the scope of this invention a fume hood wherein the fume hood is a variable air volume fume hood and, in addition, there is present an automatic sash positioning system to control the positioning of the sash in the opening.

A final embodiment of this invention is an improved fume hood wherein the improvement comprises, in combination, a fume hood having a front fascia and a moveable sash, wherein the fume hood is controlled by an automatic sash positioning system and wherein the fume hood has an active presence sensor associated with it.

There is a lighting control operator box housing a timer wherein the timer has an adjustability ranging from seconds to hours.

There is an electrical cable, electrically connected to the automatic sash positioning system and electrically connected to the control module of the automatic sash positioning system. The lighting control operator box has an electrical cable electrically connected to a fume hood lighting fixture.

It is contemplated within the scope of this invention that the exterior, active infrared presence sensor can be combined with any automatic sash positioning system, including those having variable air volume control.

Presence sensors can be any of the variety that will sense the presence in front of the fume hood. For example, it can be an infrared sensor, or an ultrasonic sensor. One such ultrasonic sensor can be purchased from Triton Controls Ltd. 4A Evenwood Industrial Estate, Bishop Auckland, Co. Durham D1149SF.

The sensor can be placed anywhere on the fume hood that will provide a path of recognition for a body in front of the fume hood. Preferred for this positioning is the front fascia of the fume hood. More preferred is a positioning on the upper part of the front fascia of the fume hood.

These presence sensors have the capability to be controlled by a timer which can be mounted anywhere on or in the fume hood. The timer can be delayed in activity and can have a timing range of from seconds to hours. Preferred for this invention is a range of from 0.05 seconds to 300 hours.

### BRIEF DESCRIPTION OF THE DRAWINGS

FIG. 1 is a full front view of a fume hood of this invention showing a moveable sash in the opening.

FIG. 2 is a full front view of a fume hood of this invention showing a set of doors in the opening.

FIG. 3 is a full front view of the fume hood of FIG. 1 showing the automatic sash operator and one position of placement.

FIG. 4 is a full top view of the fume hood of FIG. 1 in perspective, showing one mounting of the interior lighting.

### DETAILED DESCRIPTION OF THE DRAWINGS

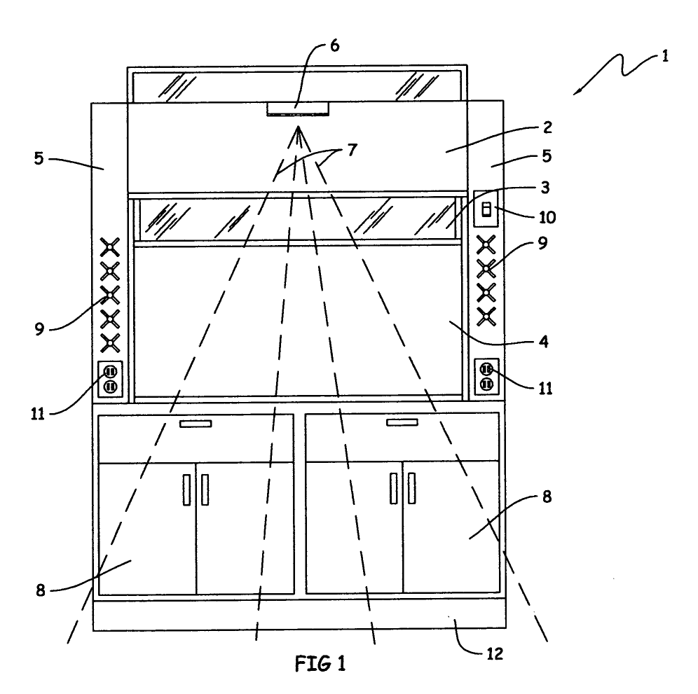

Referring now to FIG. 1, there is shown a full front view of a fume hood 1 of this invention. There is shown the front upper fascia 2, the covering 3, which is a moveable sash, the opening 4, the side fascia 5 and 5′, and an exterior mounted active sensor 6, mounted on the upper fascia 2 and above the sash 3.

Also shown is a pattern 7 showing the effective area of the sensor 6 activity. Further, there is shown the normal components of a standard hood fixture, namely, bottom cupboards 8, valve controls 9, manual electrical switch 10, electrical outlets 11 and bottom fascia 12.

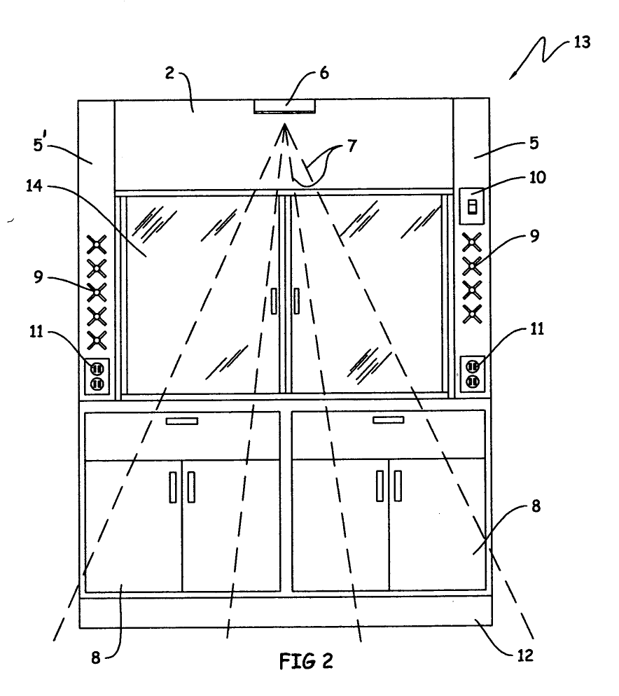

Turning to FIG. 2, there is shown a full front view of a fume hood 13 of this invention which is a fume hood having side by side doors 14 covering the opening 4 (the opening 4 not being shown in this Figure). In addition, there is shown the active sensor 6 and its pattern 7 of sensing area, the standard components, front upper fascia 2, the side fascia 5 and 5′, bottom cupboards 8, valve controls 9, manual electrical switch 10, electrical outlets 11 and bottom fascia 12.

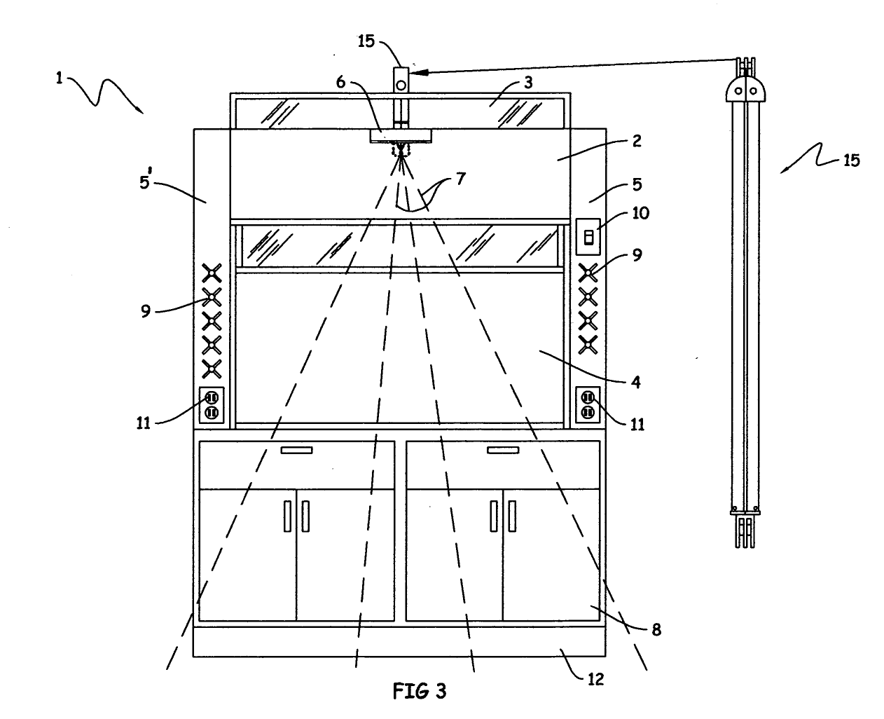

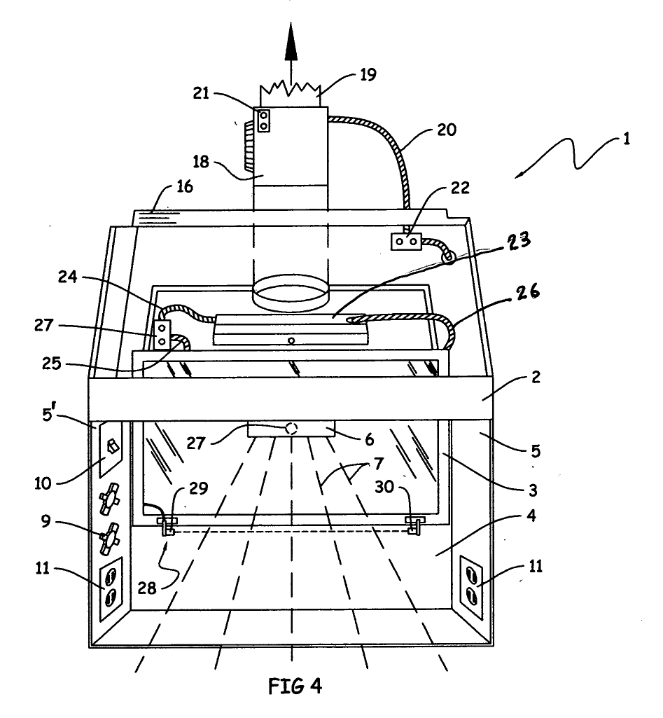

FIG. 3 is a full front view of the fume hood 1 of FIG. 1, showing the drive mechanism 15 for the moveable sash 3, along with an illustration of the drive mechanism 15, which in this case is a hydraulic or pneumatic driven mechanism. As shown in FIG. 3, the drive mechanism 15 is mounted vertically at the back 16, but this invention is not so limited (FIG. 4) and drives the sash 3 by a series of pulleys and cables (not shown because they are conventional). It is contemplated within the scope of this invention to use other drive mechanisms for the moveable sash 3. Such mechanisms can be found in U.S. Pat. No. 4,502,375, U.S. Pat. No. 4,774,878, U.S. Pat. No. 5,759,096, U.S. Pat. No. 6,024,638, and U.S. Patent publication 2006/0079164A1, among others, all of which are incorporated herein by reference for what they teach about such drive mechanisms, such as a belt drive and a clutch mechanism so that the sash member can be stopped, started, moved up or down to accommodate changes in the flow or air moving through the hood structure; pressure fluid or pneumatic cylinders; pressure sensitive switches disposed on the bottom surface of the movable sash member that provides pressure on the pressure sensitive switch in excess of a threshold limit either by a user pressing against it or by the movable sash member encountering an object left within the access opening, thereby ceasing movement of the movable sash member; pressure fluid cylinders which have no outside operating parts with respect to the movement of the piston in the cylinder, Pneumatic cylinders, and a travel interference system for the sash that can be found as a pressure sensitive switch disposed on the bottom surface of the movable sash member that provides pressure on the pressure sensitive switch in excess of a threshold limit either by a user pressing against it or by the movable sash member encountering an object left within the access opening, thereby ceasing movement of the movable sash member.

Turning now to FIG. 4, which is a full front view in perspective of the fume hood of FIG. 1, without the drive mechanism 15 and the bottom half of the fume hood, wherein there is shown the various components described heretofore wherein like numbers designate like components, and in addition, there is shown an air handling system 17 comprising a high volume motor 18, exhaust vent 19 (all of which connect to the vent opening in the top of the fume hood 1, but not necessarily close to that opening), electrical cable hook up 20, and control box 21. The electrical cable 20 is attached to an internal control box 22. When the sash 3 is open, the volume of air is automatically adjusted by the system to be at full volume and when the sash 3 is closed, the air volume is minimal. The system has the capability to adjust the air volume by positioning the sash at various opening points whereby the air volume is adjusted accordingly. Other sash operators/closure products that are contemplated within the scope of this invention are electric modules. These electric units have an electric control module that may or may not have a timer base.

Also shown in FIG. 4 is an internal lighting fixture 23, that is positioned partially outside of the fume hood 1. The lighting fixture 23 and the active presence sensor 6 are electrically coupled so that the lighting fixture 23 is turned on or off as the sensor senses something or somebody or does not sense something or somebody in the front of the fume hood 1.

A sequence of operations of the lighting controls that is in independent mode is the following:

No one is in front of the fume hood and the fume hood light is off. The user walks in front of the fume hood, the presence sensor recognizes the presence of the user and turns the fume hood light fixture on. As long as the user is sensed in front of the fume hood, the light stays on.

When the user walks away from the fume hood, the presence sensor recognizes the user is no longer within the scanned area and starts the timer. Once the timer counts down to its preset time, the fume hood light turns off.

Sequence of operation of the lighting controls using an automatic sash positioning system is the following:

IN Push Button Mode—No one is in front of the fume hood, the fume hood light is off and the sash is closed. The user walks in front of the fume hood, the presence sensor (a component of the sash controls) recognizes the presence of the user and turns the fume hood light fixture on. As long as the user is sensed in front of the fume hood, the light stays on. If the user wants to open the sash, the user needs to be sensed in front of the fume hood and press the “push to Open” button. This will open the sash. The user walks away from the fume hood, the external presence sensor (a component of the sash controls) recognizes the user is no longer within the scanned area. The control module timer and the lighting timer start counting down. Once the control module timer counts down to its pre-set time, the sash slowly closes. Once the lighting timer counts down to its pre-set time, the fume hood light turns off.

I Automatic Mode—No one is in front of the fume hood, the fume hood light is off and the sash is closed. The user walks in front of the fume hood, the presence sensor (a component of the sash controls) recognizes the presence of the user and turns the fume hood light fixture on and opens the sash. As long as the user is senses in front of the fume hood, the light stays on and the sash stays open. The user walks away from the fume hood. The presence sensor (a component of the sash controls) recognizes the user is no longer within the scanned area and starts the control module timer and the lighting timer. Once the control module timer counts down to its pre-set time, the sash will slowly close. Once the lighting timer counts down to its pre-set time, the fume hood light turns off.

The light control feature disclosed just above, is an independent function of this light control system. This can be used with sash operators, but is not required for use. If the light control system is going to be used independent of a sash operator, the light control system will be required to have its own presence sensor. The sash opening and closing does not affect the light controls. If the sash operator is in a push button or manual control mode, the light can still be automatically turned on and/or off without moving the sash, or the sash operator functioning.

Thus, and further with regard to FIG. 4, there is shown electrical cables 24, 25 and 26 and a lighting control operator box 27 housing a timer (not shown) that controls the lighting fixture 23 according to the sensing of the sensor. The electrical connection of the sensor 6 is shown in phantom at 27.

Also shown is an interior sash eye and reflector sash object detector 28, consisting of projector 29 and reflector 30.

What is claimed is:

1. An improved fume hood, the improvement comprising in combination:
a fume hood having a front fascia, a coverable opening, and a movable covering for the opening,
an active presence sensor mounted on or in the fume hood;
a lighting control operator box housing a timer said timer having adjustability ranging from seconds to hours;
an electrical cable, electrically connected to the active presence sensor and to the lighting control operator box;
the lighting control operator box having an electrical cable electrically connected to a fume hood interior lighting fixture.

2. An improved fume hood, the improvement comprising in combination:
a fume hood having a front fascia, a coverable opening, and movable doors covering the opening;
an active presence sensor mounted on or in the fume hood;
a lighting control operator box housing a timer, said timer having adjustability ranging from seconds to hours;
an electrical cable, electrically connected to the exterior, active infrared presence sensor and to the lighting control operator box;
the lighting control operator box having an electrical cable electrically connected to a fume hood lighting fixture.

3. A fume hood as claimed in claim 1, wherein there is, in addition, an automatic sash positioning system to control the positioning of the sash in the opening.

4. The improved fume hood as claimed in claim 1 wherein the fume hood is a variable air volume fume hood.

5. A fume hood as claimed in claim 1 wherein the fume hood is a variable air volume fume hood and, in addition, there is present an automatic sash positioning system to control the positioning of the sash in the opening.

6. An improved fume hood, the improvement comprising in combination:
a fume hood having a front fascia and a moveable sash, said fume hood controlled by an automatic sash positioning system;
an active presence sensor mounted on or in the fume hood;
a lighting control operator box housing a timer, said timer having adjustability ranging from seconds to hours;
an electrical cable, electrically connected to the automatic sash positioning system and electrically connected to a control module of the automatic sash positioning system;
the lighting control operator box having an electrical cable electrically connected to a fume hood lighting fixture.

7. The improved fume hood as claimed in claim 6 wherein the fume hood is a variable air volume fume hood.

8. The improved fume hood as claimed in claim 1 wherein the range on the timer is from 0.05 seconds to 300 hours.

9. The improved fume hood as claimed in claim 2 wherein the range on the timer is from 0.05 seconds to 300 hours.

10. The improved fume hood as claimed in claim 6 wherein the range on the timer is from 0.05 seconds to 300 hours.
